(19) United States
(12) Patent Application Publication
(10) Pub. No.: US 2006/0102747 A1
(43) Pub. Date: May 18, 2006

(54) Shower head

(76) Inventor: Hsin-Jon Ho, Taipei (TW)

Correspondence Address: Hsin-Jon Ho, 5 FL., 755 MIN TZU E. ROAD, TAIPEI, TW

(21) Appl. No.: 10/972,904

(22) Filed: Oct. 26, 2004

(51) Int. Cl. B05B 1/34

(52) U.S. Cl. 239/383; 239/530; 239/556

(57) ABSTRACT

Disclosed is a shower head having a pressure device formed of a vane wheel, which is rotated to give a pressure to the intake flow of water when water is guided into the shower head. The shower head comprises a casing, which has a water inlet pipe for receiving water from a water source, a spray face plate mounted in the casing for spraying water out of the casing for shower bath, a perforated cover plate covering the casing to hold the spray face member in plate, and a pressure device mounted inside the casing and adapted to give pressure to water passing through the casing toward the spray face plate. The pressure device comprises a top cover shell and a bottom cover shell sealed together, a water inlet for guiding in water from the water inlet pipe, a water outlet for guiding out water toward the spray face plate, and a vane wheel pivotally mounted in between the top cover shell and the bottom cover shell, the vane wheel defining a water accumulation chamber in fluid communication between the water inlet and the water outlet.

### BACKGROUND OF THE INVENTION

1. Field of the Invention

The present invention relates generally to a shower head and more particularly, to such a shower head that has a pressure device for giving a pressure to the intake flow of water.

2. Description of the Related Art

A variety of shower heads are commercially available for use with a faucet for shower bath. These shower heads commonly use a perforated nozzle plate for spraying fine drops of water for shower bath. These shower heads do not allow the user to adjust the open status of the holes in the perforated nozzle plate. Further, the pressure of water passing out of the perforated nozzle plate may be unstable. Further, the pressure of water passing out of the perforated nozzle plate is still low, not effective for SPA.

### SUMMARY OF THE INVENTION

The present invention has been accomplished under the circumstances in view. It is the main object of the present invention to provide a shower head, which automatically gives a pressure to the intake flow of water without consumption of electric power.

To achieve this and other objects of the present invention, the shower head comprises a casing, which has a water inlet pipe for receiving water from a water source, a spray face plate mounted in the casing for spraying water out of the casing for shower bath, a perforated cover plate covering the casing to hold the spray face member in plate, and a pressure device mounted inside the casing and adapted to give pressure to water passing through the casing toward the spray face plate. The pressure device comprises a top cover shell and a bottom cover shell sealed together, a water inlet for guiding in water from the water inlet pipe, a water outlet for guiding out water toward the spray face plate, and a vane wheel pivotally mounted in between the top cover shell and the bottom cover shell, the vane wheel defining a water accumulation chamber in fluid communication between the water inlet and the water outlet.

### BRIEF DESCRIPTION OF THE DRAWINGS

FIG. 1 is a perspective view of a shower head according to the present invention.

FIG. 2 is an exploded view of the shower head according to the present invention.

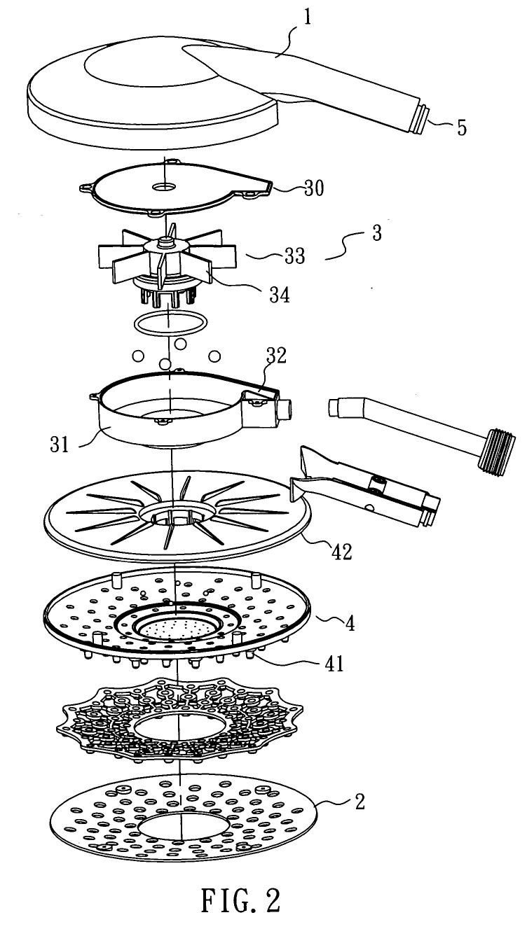

FIG. 3 is a sectional side view of the shower head according to the present invention.

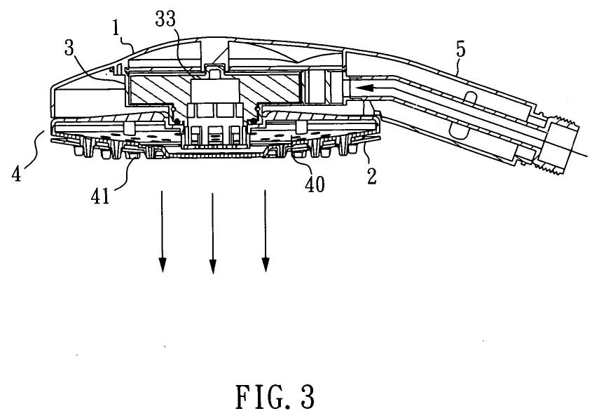

FIG. 4 is an exploded view in an enlarged scale of the pressure device according to the present invention.

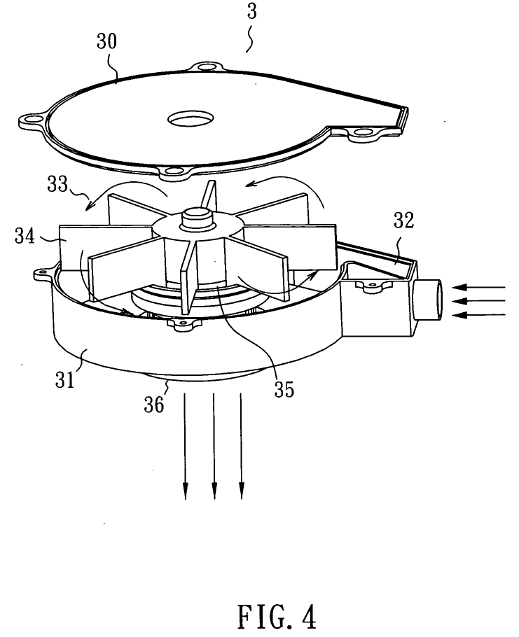

FIG. 5 is a perspective view in an enlarged scale of the vane wheel according to the present invention.

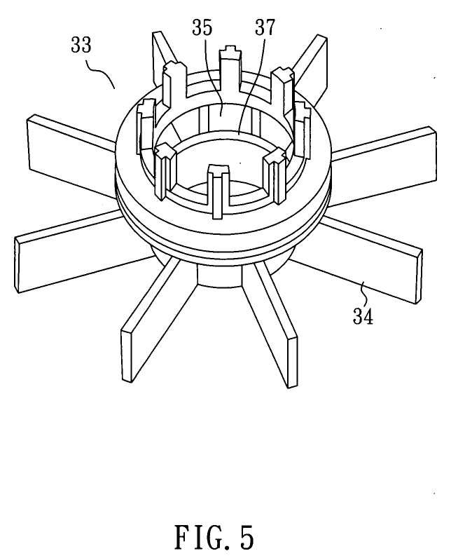

FIG. 6 is an exploded view in an enlarged scale of the spray face member according to the present invention.

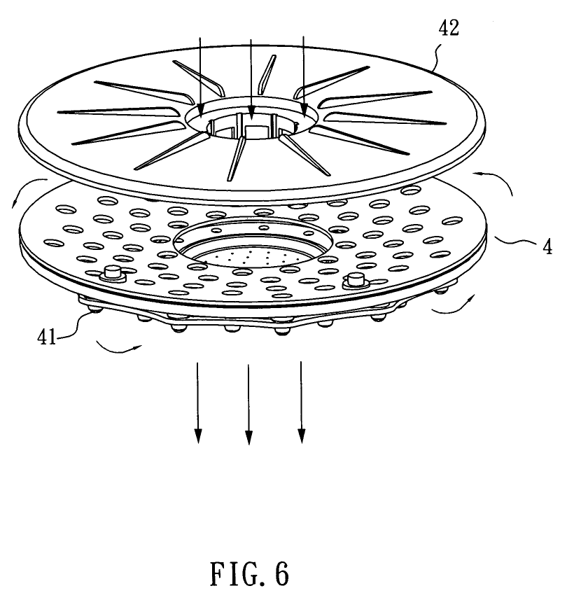

### DETAILED DESCRIPTION OF THE INVENTION

Referring to the annexed drawings in detail, a shower head in accordance with the present invention is shown comprised of a casing 1, a perforated front cover plate 2, a pressure device 3, and a spray face member 4.

The casing 1 is provided with a water inlet pipe 5 for receiving water from a water source. The pressure device 3 is mounted inside the casing 1, comprised of a top cover shell 30, a bottom cover shell 31, and a vane wheel 33. The top cover shell 30 and the bottom cover shell 31 are sealed together to accommodate the vane wheel 33, defining a water passage 32 for guiding in water from the water inlet pipe 5. The vane wheel 33 is pivotally mounted in between the top cover shell 30 and the bottom over shell 31, having a bottom water accumulation chamber 35 and a plurality of vanes 34 spaced around the periphery. The bottom cover shell 31 has a center through hole 36 in fluid communication with the bottom water accumulation chamber 35 of the vane wheel 33 for water output. The vane wheel 33 has a plurality of flow guide plates 37 for guiding water toward the center through hole 36 of the bottom cover shell 31 in a spiral manner. The spray face member 4 is comprised of a front jet nozzle plate 41 and a back dial plate 42. The front jet nozzle plate 41 and the back dial plate 42 are attached together and pivotally mounted in the casing 1 in front of the pressure device 3. The perforated front cover plate 2 is fastened to the casing 1 to hold the spray face member 4 in place.

When in use, the water inlet pipe 5 is connected to the faucet (not shown) to receive city water. When opened the faucet, city water flows through the water inlet pipe and the water passage 32 of the pressure device 3 to move the vanes 34 of the vane wheel 33, thereby causing the vane wheel 33 to rotate. During rotary motion of the vane wheel 33, the vanes 34 give a pressure to intake flow of water, propelling intake flow of water into the bottom water accumulation chamber 35. Continuous supply of water into the bottom water accumulation chamber 35 causes a high pressure flow of water to be forced out of the bottom water accumulation chamber 35 and guided by the flow guide plates 37 into the spray face member 4 through the center through hole 36 of the bottom cover shell 31, and therefore high pressure flow water is ejected out of the jet nozzles of the front jet nozzle plate 41 via water holes 40 in the back dial plate 42. Further, the user can rotate the back dial plate 42 to regulate the open status of the jet nozzles of the front jet nozzle plate 41.

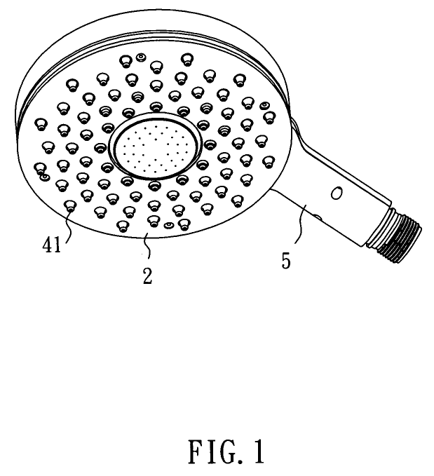

A prototype of shower head has been constructed with the features of FIGS. 1˜6. The shower head functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A shower head comprising:
a casing, said casing having a water inlet pipe for receiving water from a water source;
a spray face plate mounted in said casing for spraying water out of said casing for shower bath; and
a perforated cover plate covering said casing to hold said spray face member in plate;
wherein a pressure device is mounted inside said casing and adapted to give pressure to water passing through said casing toward said spray face plate, said pressure device comprising a top cover shell and a bottom cover shell sealed together, a water inlet for guiding in water from said water inlet pipe, a water outlet for guiding out water toward said spray face plate, and a vane wheel pivotally mounted in between said top cover shell and said bottom cover shell, said vane wheel defining a water accumulation chamber in fluid communication between said water inlet and said water outlet.

2. The shower head as claimed in claim 1, wherein said spray face plate comprises a front jet nozzle plate affixed to said casing, and a back dial plate rotatable relative to said front jet nozzle plate for regulating passage of water through said front jet nozzle plate.
